(19) United States
(12) Patent Application Publication
(10) Pub. No.: US 2008/0136175 A1
(43) Pub. Date: Jun. 12, 2008

(54) Rolled Compression Fitting

(75) Inventors: Robert C. Hansen, North Muskegon, MI (US); Donald E. Karhoff, Bancroft, MI (US)

Correspondence Address: MCGARRY BAIR PC, 32 Market Ave. SW, SUITE 500, GRAND RAPIDS, MI, 49503, US

(73) Assignee: BLD PRODUCTS, LTD, Holland, MI (US)

(21) Appl. No.: 11/551,332

(22) Filed: Oct. 20, 2006

(51) Int. Cl. F16L 33/00

(52) U.S. Cl. 285/245

(57) ABSTRACT

A compression sleeve comprises a rolled blank having opposing ends coupled together to form a tubular body. A method of forming a compression sleeve comprises forming a blank having opposing ends. At least one notch with at least one relief portion is formed in the blank. The blank is rolled to form a tubular configuration, and the opposing ends are coupled to maintain the tubular configuration.

### BACKGROUND OF THE INVENTION

1. Field of the Invention

This invention generally relates to a compression fitting for fluid connections.

2. Description of the Related Art

Compression fittings are currently used to connect a conduit to a coupling in such a way to prevent the escape of fluid between the interface of the conduit with the coupling, especially in environments where the conduit carries pressurized gases, such as air. Compression fittings work by pressing the conduit against a portion of the coupling to effect a seal that will withstand the anticipated pressures within the conduit and prevent the escape of fluid through the interface.

Some compression fittings use a sleeve that is physically deformed to press the conduit against the coupling. The sleeves are currently machined from a tubular stock and often require multiple machining operations, which is undesirable for a high volume, low cost part.

### SUMMARY OF THE INVENTION

The invention provides a more economical means of manufacturing compression sleeves. In one aspect, the invention is a compression sleeve comprising a rolled blank having opposing ends coupled together to form a tubular body. At least one notch having a relief portion is formed in the rolled blank. The relief portion enables the rolling of the blank without creasing.

In another aspect, the invention is a method of forming a compression sleeve comprising forming a blank having opposing ends and at least one notch with at least one relief portion. The blank is rolled to form a tubular configuration, and the opposing ends are coupled to maintain the tubular configuration.

In a third aspect, the invention is a compression fitting comprising a first body, a second body, and a rolled compression sleeve. The first body defines a seat for receiving a compressible element. The second body is mountable to the first body. The rolled compression sleeve is located between the first body and the second body such that a portion of the compression sleeve compresses a portion of the compressible element against the seat when the first body is mounted to the second body.

### BRIEF DESCRIPTION OF THE DRAWINGS

FIG. 1 is an exploded view of a compression fitting according to the invention as it would be installed on a conduit and body.

FIG. 2 is a perspective view of a compression sleeve from the compression fitting of FIG. 1.

FIG. 3 is a side view of the compression sleeve of FIG. 3.

FIG. 4 is a top view of the compression sleeve of FIG. 3.

FIG. 5 is a sectional view taken along line 6-6 of FIG. 5.

FIG. 6 is a plan view of the outer surface of the blank used to form the compression sleeve of FIG. 3.

FIG. 7 is a plan view of the outer surface of the stamping created from the blank of FIG. 6 and used to form the compression sleeve of FIG. 3.

FIG. 8 is a plan view of the inner surface of the stamping of FIG. 7.

FIG. 9 is a sectional view of the compression fitting of FIG. 1 installed on a conduit and body.

FIG. 10 is a perspective view of the compression fitting of FIG. 1 installed on a conduit and body.

### DESCRIPTION OF THE EMBODIMENT

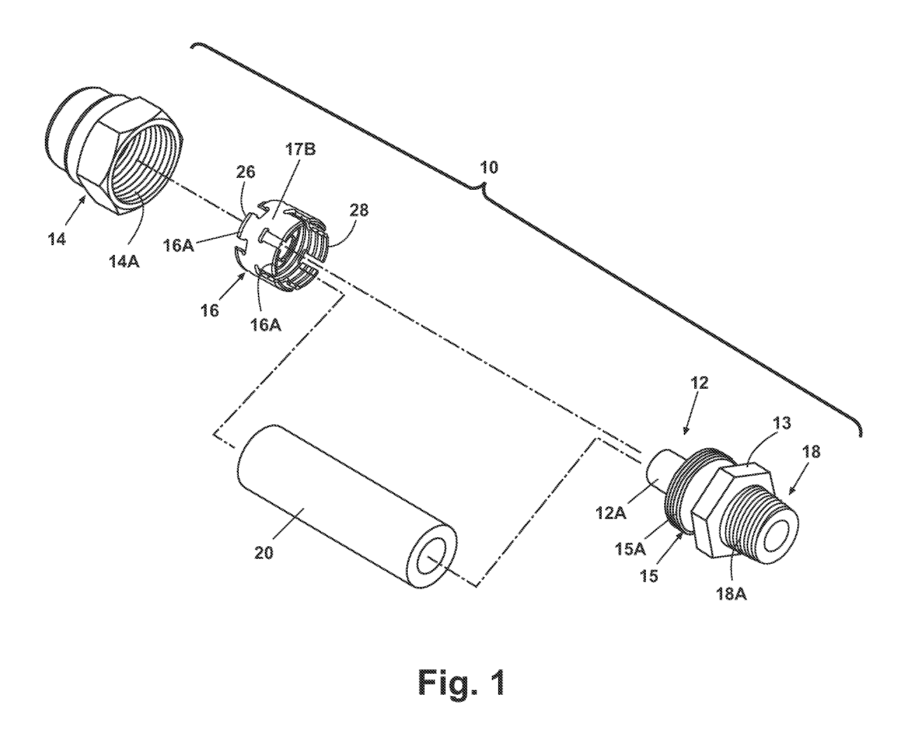

FIG. 1 illustrates a compression fitting according to the invention, designated generally by the numeral 10. The compression fitting 10 comprises a body 12, a stopper nut 14, and a compression sleeve 16. The stopper nut 14 and sleeve 16 compressively retain a compressive element illustrated herein as a conduit 20 to the coupling 12.

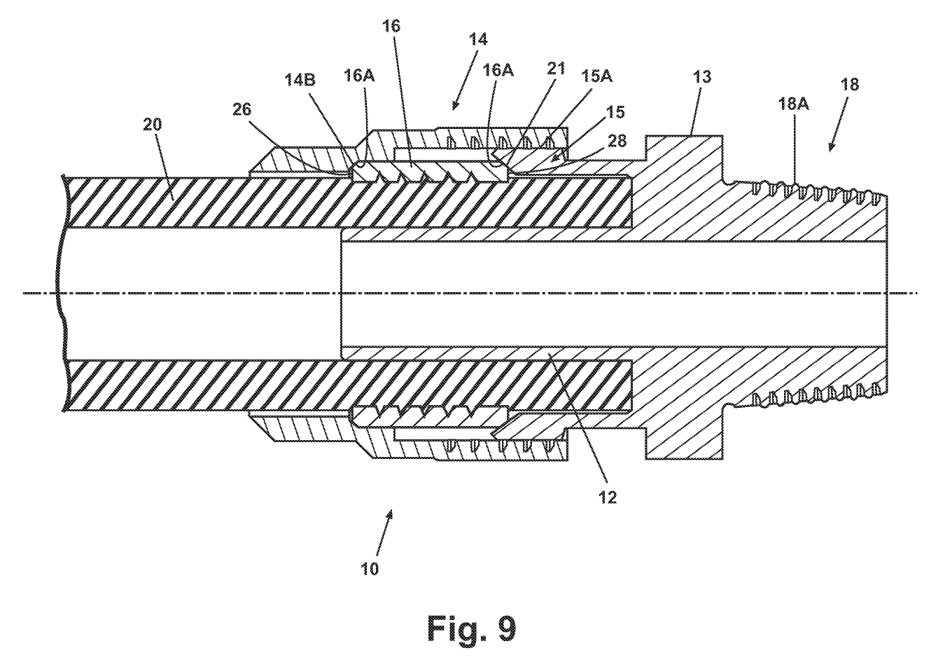

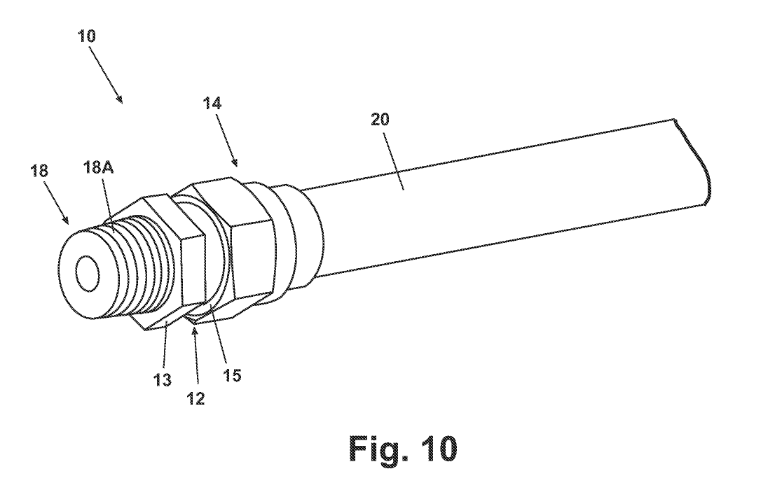

As illustrated, the coupling 12 defines a passageway through which fluid can flow and comprises a seat 12A, a body nut 13, and a collar 15, which are aligned coaxially. The seat 12A is located at one end of the coupling 12. The body nut 13 is located on the end of the coupling 12 opposite the seat 12A and is illustrated as having a hexagonal shape so as to enable tightening by a traditional wrench. The collar 15 comprises a threaded exterior 15A. The collar 15 is spaced radially outward about a portion of the seat 12A to define an annular channel 15B between the collar 15 and the seat 12A (FIG. 9). An angled interior annular ledge of the collar 15 defines a deflector 21 (FIG. 9).

An end connector 18 aligned coaxially with the coupling 12 extends axially outward adjacent the body nut 13 and comprises a threaded exterior 18A. While the end connector 18 is illustrated as a threaded annulus, it can be any component enabling connection of another component and the flow of fluid or gas there through. Preferably, the coupling 12 and end connector 18 are formed integrally. Alternatively, the end connector 18 can be formed separately of a relatively rigid material, such as copper, and attached by welding.

The stopper nut 14 comprises a threaded interior portion 14A for threadably receiving the threaded exterior 15A of the collar 15. The stopper nut 14 further comprises an interior stop 14B in the form of an annular wall adapted to limit axial movement of the compression sleeve 16. The stopper nut 14 has a hexagonal portion on its exterior so as to enable tightening by a wrench, as is well known in the art.

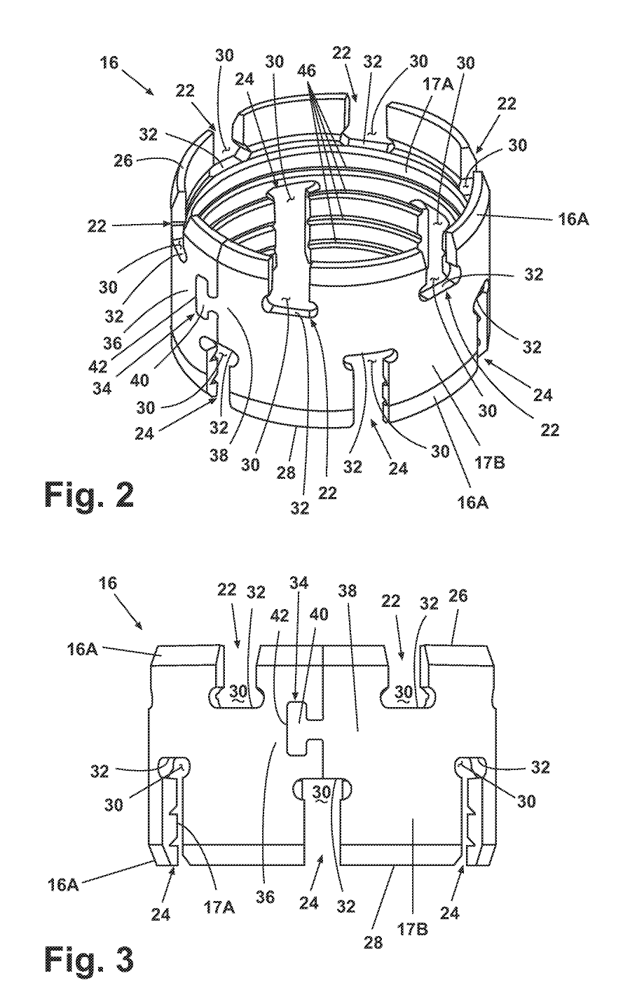

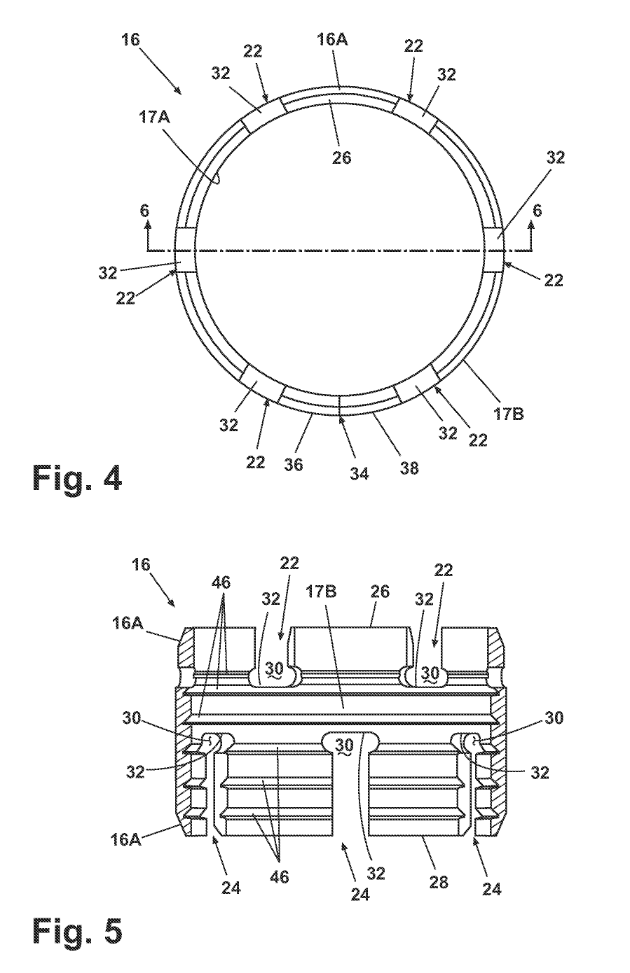

Referring now to FIGS. 2-5, the compression sleeve 16 has a tubular shape. The compression sleeve 16 is illustrated as an annulus. The compression sleeve 16 comprises an inner surface 17A and outer surface 17B. The compression sleeve 16 further comprises an upper edge 26 and a lower edge 28. The compression sleeve 17 can also comprise two optional tapers 16A, with one taper 16A being adjacent to each of the upper edge 26 and lower edge 28. The tapers 16A are angled transitional surfaces that extend from an upper portion and a lower portion of the outer surface 17B to the upper edge 26 and lower edge 28 respectively.

The compression sleeve 16 includes a plurality of upper notches 22 and/or lower notches 24. The upper notches 22 and the lower notches 24 each comprise a cut made in the upper edge 26 or the lower edge 28 respectively. Preferably, the upper notches 22 and lower notches 24 are generally rectangular in shape. The upper notches 22 and lower notches 24 can be dissimilar in dimensions. The upper notches 22 can be radially offset from the lower notches 24. Each of the upper notches 22 and lower notches 24 includes a relief portion 30. The relief portion 30 is an enlarged area of the upper notch 22 or lower notch 24 and is preferably located at a tip 32. The tip 32 is the portion of the upper notch 22 or lower notch 24 furthest away from the upper edge 26 or lower edge 28 respectively.

The compression sleeve 16 further comprises a connector 34 coupling two opposing ends 36, 38. The connector 34 preferably consists of a projection 40 and a recess 42. The projection 40 extends from one of the opposing ends 36 to be received in the recess 42 in the other opposing end 38. Preferably, the projection 40 has an enlarged tip 44 and is formed integrally with the compression sleeve 16. The enlarged tip 44 is a widened portion of the projection 40 located furthest from the opposing end 36 from which it extends. The recess 42 is complimentary in shape to the projection 40.

The compression sleeve 16 can include a plurality of grooves 46 on its inner surface 17A, as is shown in FIG. 5. The grooves 46 are outwardly extending channels which are of a depth less than the thickness of the compression sleeve 16. The grooves 46 are illustrated as being oriented parallel to one another, but can have other orientations.

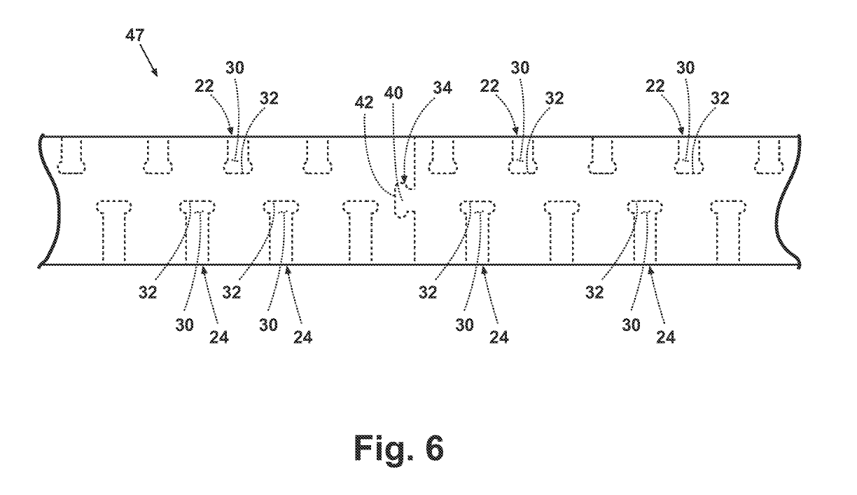

Turning now to FIG. 6, a blank 47 used to form the compression sleeve 16 is shown. The blank is a relatively thin metal blank of a constant thickness, such as a brass alloy blank. Multiple compression sleeves 16 can be formed from a single blank 47, as is illustrated.

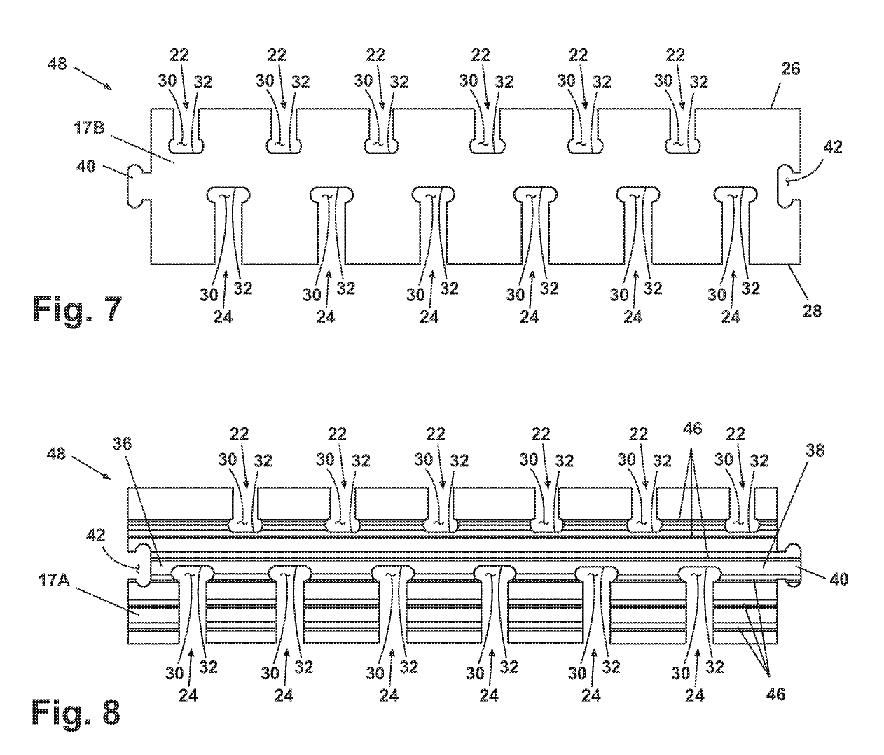

As shown in FIGS. 7-8, the blank 47 is stamped to form the tapers 16A, upper notches 22, lower notches 24, relief portions 30, the connector 34, and grooves 46, creating a stamping 48. The inner surface 17A, outer surface 17B, upper edge 26, and lower edge 28 are also made relatively smooth by removing any burrs on the stamping 48, as is well-known in the art.

A process other than stamping can be used to cut the blank 47. For example, a laser can cut the blank 47. For purposes of this description, the cut blank is referred to a stamping 48 regardless of the manner in which the blank is cut.

Once the stamping 48 has been formed, it is subjected to rolling. The rolling causes the stamping 48 to curl and form a tubular shape. The rolling also causes the opposing ends 36, 38 to confront each in a manner wherein the recess 42 receives the projection 40, thus creating the annular compression sleeve 16. The enlarged tip 44 of the projection 40 prevents the projection 40 from being withdrawn from the recess 42 in order to maintain the connection between the opposing ends 36, 38. During rolling, the relief portions 30 of both the upper notches 22 and lower notches 24 prevent any creasing of the stamping 48, leaving the outer surface 17B of the compression sleeve 16 smooth.

Looking now to FIGS. 9 and 10, once the compression sleeve 16 is formed, the compression fitting 10 is used by first inserting the seat 12A of the coupling 12 completely into the conduit 20. The compression sleeve 16 is slid onto the end of the conduit 20 not received by the seat 12A. For the purpose of describing the invention, installation will be described with compression sleeve 16 sliding onto the conduit with the lower edge 28 first, although it would be equally acceptable to instead slide the upper edge 26 onto the conduit 20 first. Once on the conduit 20, the compression sleeve 16 is slid over the length of the conduit 20 and as far as possible onto the portion of the conduit 20 encasing the seat 12A. The stopper nut 14 is then slid onto the end of the conduit 20 not received by the seat 12A with the portion having the threaded interior 14A first. Once on the conduit 20, the stopper nut 14 is slid over the length of the conduit 20 to a position over the compression sleeve 16. The threaded interior 14A of the stopper nut 14 can then be threaded onto the threaded exterior 15A of the collar 15 by holding the coupling 12 in one hand and turning the stopper nut 14 with the other hand. If the stopper nut 14 becomes too difficult to turn by hand, a wrench can be used to tighten the stopper nut 14 about the collar 15.

As the stopper nut 14 is tightened, the stop 14B presses against the taper 16A adjacent the upper edge 26 of the compression sleeve 16 to prevent the compression sleeve from moving away from the coupling 12. The stop 14B also serves to press the compression sleeve 16 into the conduit 20. The deflector 21 presses against the taper 16A adjacent the lower edge 28 by the tightening of the stopper nut 14, which in turn presses the compression sleeve 16 into the conduit 20 and against the stop 14B. The grooves 46 of the compression sleeve 16 anchor the compression sleeve 16 to the conduit 20, which helps to prevent slippage of the compression fitting 10. The conduit 20 compresses tightly onto the seat 12A due to the applied forces, creating an impermeable connection, as is shown in FIGS. 9 and 10.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A compression sleeve comprising:
a rolled blank having opposing ends coupled together to form a tubular body; and
at least one notch formed in the rolled blank and having a relief portion, wherein the relief portion enables the rolling of the blank without creasing.

2. The compression sleeve according to claim 1, wherein the tubular body is in the shape of an annulus.

3. The compression sleeve according to claim 1, and further comprising a connector coupling the opposing ends.

4. The compression sleeve according to claim 3, wherein the connector is integrally formed with the blank.

5. The compression sleeve according to claim 4, wherein the connector comprises a projection on one of the opposing ends and a recess on the other of the opposing ends, wherein the projection is received within the recess to couple the opposing ends.

6. The compression sleeve according to claim 5, wherein the projection has an enlarged tip.

7. The compression sleeve according to claim 6, wherein the recess is complementary in shape to the projection.

8. The compression sleeve according to claim 4, wherein the relief portion comprises an enlarged area of the notch.

9. The compression sleeve according to claim 8, wherein the notch comprises at least one corner and the enlarged area is located at the corner.

10. The compression sleeve according to claim 1, wherein the relief portion comprises an enlarged area of the notch.

11. The compression sleeve according to claim 10, wherein the notch comprises at least one corner and the enlarged area is located at the corner.

12. The compression sleeve according to claim 1, wherein the tubular body comprises internal threads.

13. A method of forming a compression sleeve, comprising:
forming a blank having opposing ends and at least one notch with at least one relief portion;
rolling the blank to form a tubular configuration; and
coupling the opposing ends to maintain the tubular configuration.

14. The method according to claim 13, wherein the rolling of the blank does not crease the blank.

15. The method according to claim 13, wherein the coupling of the opposing ends comprises inserting a projection on one end into a recess on the other end.

16. The method according to claim 13, wherein the forming of the blank comprises forming a plurality of notches along at least one of an upper edge and lower edge of the blank.

17. The method according to claim 16, wherein the forming of the blank comprises forming a plurality of notches along both an upper edge and a lower edge of the blank.

18. The method according to claim 17, wherein the notches along the upper edge are radially offset from the notches on the lower edge.

19. The method according to claim 17, wherein the forming of the blank comprises forming threads on the blank.

20. A compression fitting comprising:
a first body defining a seat for receiving a compressible element;
a second body mountable to the first body; and
a rolled compression sleeve located between the first body and the second body such that a portion of the compression sleeve compresses a portion of the compressible element against the seat when the first body is mounted to the second body.

21. A compression fitting according to claim 20 wherein the compression sleeve comprises a rolled blank having opposing ends coupled together to form a tubular body, with at least one notch formed in the rolled blank and having a relief portion, wherein the relief portion enables the rolling of the blank without creasing.

22. The compression fitting according to claim 21, and further comprising a connector coupling the opposing ends.

23. The compression fitting according to claim 22, wherein the connector comprises a projection on one of the opposing ends and a recess on the other of the opposing ends, wherein the projection is received within the recess to couple the opposing ends.

24. The compression fitting according to claim 23, wherein the projection has an enlarged tip and the recess is complementary in shape to the projection.

25. The compression fitting according to claim 20, wherein the relief portion comprises an enlarged area of the notch.

26. The compression fitting according to claim 25, wherein the notch comprises at least one corner and the enlarged area is located at the corner.

27. The compression fitting according to claim 21, wherein at least one of the first body and second body comprises a deflector that deflects at least a portion of the compression sleeve into the compressible element to compress the compressible element against the seat.

28. The compression fitting according to claim 27, wherein the second body is mounted to the first body by one of the first body and the second body being axially received within the other of the first body and the second body to bring the deflector into contact with the compression sleeve and effect the deflection of the compression sleeve.
